(19) United States
(12) Patent Application Publication
(10) Pub. No.: US 2019/0368472 A1
(43) Pub. Date: Dec. 5, 2019

(54) DEVICE AND METHOD FOR RECOGNIZING THE ATTACHMENT OF ICE TO A STRUCTURE OF AN EDIFICE

(71) Applicant: FOS4X GMBH, München (DE)

(72) Inventor: Mathias MÜLLER, Grobenzell (DE)

(21) Appl. No.: 16/470,183

(22) PCT Filed: Dec. 15, 2017
(86) PCT No.: PCT/EP2017/083088

§ 371 Date: Jun. 14, 2019

(30) Foreign Application Priority Data
Dec. 15, 2016 (DE) 10 2016 124 554.2

(51) Int. Cl. F03D 80/40; F03D 17/00; G08B 19/02

(52) U.S. Cl. CPC F03D 80/40; F03D 17/00; F05B 2260/80; F05B 2220/30; G08B 19/02

(57) ABSTRACT

Embodiments of the present disclosure relate to a device and a method for recognising the attachment of ice to a structure (110) of a construction (100). The device comprises at least one acceleration sensor (10) that is arranged and configured to detect an acceleration on the structure; an evaluation device (30) for determining at least one natural frequency of the structure (110) from the detected acceleration, wherein the evaluation device (30) is configured to indirectly detect attachment of ice to said structure (110) on the basis of the determined natural frequency of the structure (110); and at least one ice detection sensor (20, 20a, 20b) that is arranged and configured to directly detect attachment of ice at a position on said structure (110), wherein the evaluation device (30) combines the indirect detection of the attachment of ice and the direct detection of the attachment of ice.

### TECHNICAL FIELD

Embodiments of the present disclosure relate to a device and a method for recognizing the attachment of ice to a structure of an edifice.

Structures of edifices are exposed in an unprotected manner to the environmental weather conditions. One example of a structure is the rotor blade of a wind turbine. At certain locations, ice may deposit at the structures, e.g. the rotor blades, when the environmental temperatures are correspondingly low and the air humidity is sufficiently high or when rainfall occurs. With an increase in size of the structures, such as e.g. the rotor blades of wind turbines, their surface increases so that the risk of an attachment of ice, i.e. the formation of an ice deposit on the structures increases as well.

Ice attachments, on the one hand, constitute a potential danger for the environment of the edifice, since, when the ice attachment is thrown out—e.g. in the rotating operation of a wind turbine—the thrown-out ice pieces may endanger persons and objects in the throw-out radius. On the other hand, in particular in the event of a non-uniform attachment of ice, an imbalance of the rotor of the wind turbine may result which may lead to damages in the operation of the wind turbine.

### STATE OF THE ART

Devices and methods for recognizing the attachment of ice to rotor blades of wind turbines are known. Some known devices and methods evaluate signals of an acceleration sensor mounted to the rotor blade or in the area of the rotor blade, in order to gather information as to a possible attachment of ice.

The mass of attached ice may be relatively small in relation to the mass of a rotor blade. The accuracy or resolution of an acceleration sensor or the related evaluation method is therefore limited.

A solution should therefore be proposed which allows the attachment of ice to a structure of an edifice to be recognized in a more reliable and accurate manner.

### SUMMARY

Embodiments of the present disclosure provide a device for recognizing the attachment of ice to a structure of an edifice according to claim 1. Further embodiments of the present disclosure propose a method for recognizing the attachment of ice to a structure of an edifice according to claim 10.

According to one embodiment, a device for recognizing the attachment of ice to a structure of an edifice is proposed, wherein the device comprises at least one acceleration sensor that is arranged and configured to detect an acceleration on the structure, wherein the device comprises an evaluation device for determining at least one natural frequency of the structure from the detected acceleration, wherein the evaluation device is configured to indirectly detect attachment of ice to said structure on the basis of the determined at least one natural frequency of the structure, and wherein the device comprises at least one ice detection sensor that is arranged and configured to directly detect attachment of ice at a position on said structure, wherein the evaluation device combines the indirect detection of the attachment of ice and the direct detection of the attachment of ice.

According to a further embodiment, a method for recognizing the attachment of ice to a structure of an edifice is proposed, wherein the method comprises detecting an acceleration on the structure, determining at least one natural frequency of the structure from the detected acceleration, indirectly detecting attachment of ice to the structure on the basis of the determined at least one natural frequency of the structure, directly detecting attachment of ice at a position on said structure, and determining from the combination of the direct detection result and the indirect detection result, whether ice attachment is given or not.

Further aspects and features will result from the features of the dependent claims, for example

### BRIEF DESCRIPTION OF DRAWINGS

Embodiments of the invention are illustrated in the drawings and explained in more detail in the following description. Shown are in the drawings:

FIG. 1 a schematic block diagram of a device for recognizing the attachment of ice to a structure of an edifice according to one embodiment;

FIG. 2 a schematic representation of a wind turbine, in which the device according to one of the embodiments described herein may be employed; and

FIG. 3 a flow chart of a method for recognizing the attachment of ice to a structure of an edifice according to one embodiment.

In the following, embodiments will be explained in more detail. The drawings serve the purpose of illustrating one or more examples of embodiments of the invention.

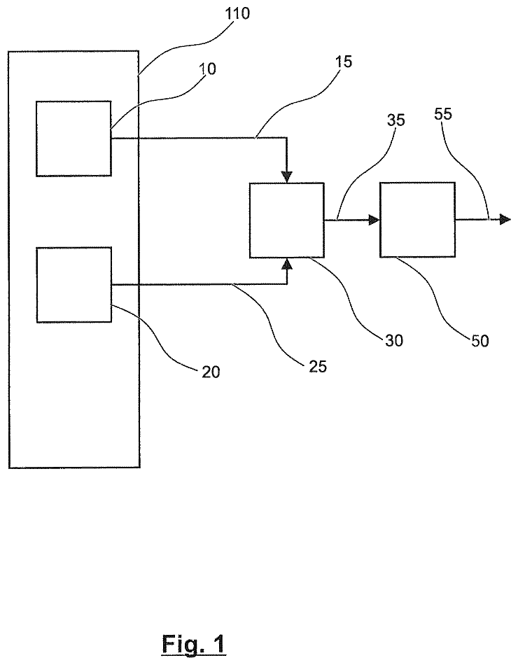

FIG. 1 schematically shows a block diagram of a device for recognizing the attachment of ice to a structure 110 of an edifice according to the embodiment. Typically, the structure 110 of the edifice is movable, for example, supported to be rotatable relative to a foundation of the edifice or the like. A non-limiting example of an edifice is a wind turbine, and a likewise non-limiting example of a structure 110 of the wind turbine is a rotor blade.

An acceleration sensor 10 is arranged and configured in a manner to detect an acceleration on the structure 110. For example, the acceleration sensor 10 is arranged in a rotor blade or on a rotor blade of a wind turbine. Typically, the acceleration sensor 10 detects the acceleration in a time-continuous manner, and outputs the acceleration in a time-continuous manner, e.g. as a data stream of temporally equidistant sample values. The acceleration sensor 10 supplies the detected acceleration as an acceleration signal 15 to an evaluation device 30.

The evaluation device 30 is supplied with the acceleration signal 15 via a suitable medium; an electric line, an optical line or a wireless transmission should be mentioned as non-limiting examples.

It may also be provided for the acceleration sensor 10 to measure accelerations in a plurality of axial directions, for example, in two axial directions or in three axial directions. In addition, the disclosure is not restricted to one single acceleration sensor 10, rather two or more accelerations sensors may be provided on the structure 110, typically at different points on or in the structure 110.

The evaluation device 30 is configured to determine a natural frequency of the structure 110 or a plurality of natural frequencies of the structure 110 from the detected acceleration (from the acceleration signal 15). The evaluation device is further configured to indirectly detect an attachment of ice on the structure based on the detected at least one natural frequency of the structure 110.

For detecting the at least one natural frequency, the evaluation device 30, for example, is configured to transform a measurement value progress of the acceleration sensor into the frequency domain, for example, by a Fourier transform or another suitable integral transformation. A natural frequency of the structure 110 may show, for example, as a frequency excess (a peak) in the transformed signal. The disclosure is not restricted to a single natural frequency, and a plurality of natural frequencies of the structure 110 may also be referred to for the indirect detection.

It should be noted here that a spatial or technical separation between the evaluation device 30 and the acceleration sensor 10 must be given necessarily; the evaluation device 30 and the at least one acceleration sensor 10 rather may be designed to be integrated.

Indirectly detecting, as used herein, means that the presence or absence of an ice attachment is derived from a parameter directly associated to an ice attachment. In the exemplary embodiment, it is indirectly concluded based on the natural frequency of the structure 110 which changes with a change of the mass of the structure 110, that the changed natural frequency indicates an ice attachment to the structure 110.

In addition, an ice detection sensor 20 is arranged and configured in a manner to directly detect the attachment of ice at a position on the structure 110. Directly detecting, as used herein, comprises measuring a parameter directly indicating an ice attachment. In embodiments, the ice detection sensor 20 for directly detecting is selected from the group comprising: an impedance sensor, an electrical resistance sensor, an ultrasonic sensor, an optical sensor for measuring a light intensity or a change in light intensity, an optical sensor for measuring a light wavelength or a change in light wavelength, a fiber Bragg grating sensor.

The ice detection sensor 20 detects the attachment of ice typically at a position on the structure 110 in a spatially limited detection area. For example, the ice detection sensor 20 is designed to directly detect the attachment of ice directly within a detection radius of 1 m or 50 cm in the area of the position on the structure 110.

The ice detection sensor 20 outputs an ice detection signal 25 with which the evaluation device 30 is supplied. The evaluation device 30 is supplied with the ice detection signal 25 via a suitable medium; an electric line, an optical line or a wireless transmission should be mentioned as non-limiting examples. The ice detection signal 25, for example, is a binary signal indicating the presence or absence of attached ice. The ice detection signal 25 may as well be a signal which can assume more than two values. For example, the ice detection signal may indicate an appropriately coded value of the ice thickness or ice volume at the position on the structure or in the detection area at the position of the structure 110.

The evaluation device 30 is configured to combine the indirect detecting of the attachment of ice and the direct detecting of the attachment of ice. The evaluation device 30 typically combines an indirect detection result which is derived from the evaluation described here of the determined at least one natural frequency with a direct detection result derived from the ice detection signal 25.

The indirect detection result is based on the evaluation of a natural frequency or of natural frequencies of the structure 110. Thereby, large or extensive areas of the structure 110 are in principle implied in the detection with a low number of acceleration sensors 10. The change in mass in the event of ice attachment on the structure 110, however, may be small. In particular a rotor blade of a wind turbine has a mass which in some cases is very large in relation to the mass of attached ice. In addition, there may be areas on the structure where an ice attachment has only a minor effect on the natural frequency or natural frequencies, for example, in the area of a blade root of a rotor blade of a wind turbine. The detection accuracy or the resolution of the indirect detection may therefore be limited depending on the case.

The combination of the indirect and direct detection result allows the detection accuracy or the reliability or the resolution of the device for recognizing the attachment of ice as described herein to be improved. In addition, the indirect detection result may even be determined when accelerations do not occur on the structure 110 in a period of time and thus natural frequencies cannot be determined, for example, when the rotor blade of a wind turbine is at standstill.

In embodiments, the indirect detecting of the attachment of ice to the structure 110 comprises comparing the determined at least one natural frequency with at least one reference natural frequency, and determining a shift between the determined at least one natural frequency and the at least one reference natural frequency.

The reference natural frequency, for example, is a basic value of a natural frequency of the structure 110 in a state free of ice attachment. The basic value may be determined, for example, by a reference measurement of the natural frequency in the state free of ice attachment or by simulation. The shift between the determined natural frequency and the reference natural frequency, for example, is a shift between the determined natural frequency and the basic value.

In embodiments, the combining of indirectly detecting the attachment of ice and of directly detecting the attachment of ice comprises determining, in the indirect detection, that an attachment of ice is given when a shift between the determined at least one natural frequency and the at least one reference natural frequency exceeds a previously defined or definable threshold value of shift, and determining, in the direct detection, that an attachment of ice is given when a detection value of the attachment of ice exceeds a previously defined or definable threshold value of ice thickness.

The previously defined or definable threshold value of shift, for example, may be an equivalent shift where a determination is made that a certain change of mass or increase of mass has occurred. An increase of mass may be, for example, at least 50 kg or at least 20 kg.

The previously defined or definable threshold value of ice thickness, for example, may be an equivalent ice volume or an equivalent ice thickness, where a determination is made that a certain increase of mass has occurred.

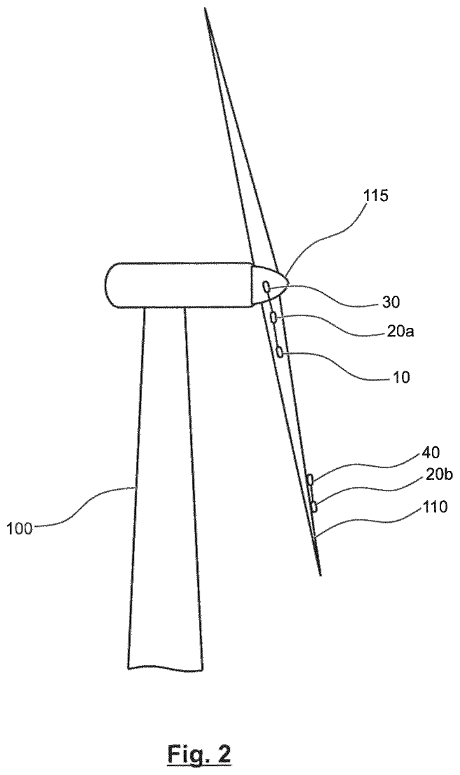

FIG. 2 shows a schematic representation of a wind turbine, in which the device according to one of the embodiments described herein may be employed.

In embodiments, it is provided for the at least one ice detection sensor 20a, 20b to be arranged at one or more positions of the group comprising: the area of the rotor blade front edge of a rotor blade of a wind turbine, the area of the rotor blade tip of a rotor blade of a wind turbine, the area of the rotor blade root of a rotor blade of a wind turbine. The disclosure is not restricted to the mentioned positions and it may be provided for individual or the entirety of the ice detection sensors 20a, 20b to be arranged or attached at positions differing from the mentioned positions.

The rotor blade front edge belongs to the areas where ice attaches particularly rapidly, since the cold and humid air directly impinges the blade here. On the rotor blade root, as well, ice forms rapidly. Moreover, the ice attachment forms all the more rapidly the closer the position is to the rotor blade tip, since the blade moves fastest here.

It may be that ice attachments of importance for the operation of the wind turbine are already present in these areas when the detection accuracy and the resolution of the indirect detection are not yet sufficient to recognize these attached ice volumes. By one or more ice detection sensors 20a, 20b being provided or present in the mentioned areas, the detection accuracy of the device can be improved.

In the embodiment according to FIG. 2, an ice detection sensor 20a is provided in the area of the blade root and arranged in the rotor blade. A further ice detection sensor 20b is provided in the area of the rotor blade tip at a rotor blade front edge and glued to the rotor blade in the area of the rotor blade tip in the illustrated embodiment. The disclosure, however, is not restricted to two ice detection sensors 20a, 20b, and only one ice detection sensor 20 may be provided, or more than two ice detection sensors 20a, 20b may be provided. Typically, more than ten or more than fifteen ice detection sensors are provided on a structure 110.

In embodiments, it is provided for the at least one acceleration sensor 10 and/or the at least one ice detection sensor 20, 20a, 20b to be configured to supply the evaluation device 30 in a wireless manner with the detected acceleration or the direct detection result.

In the embodiment illustrated in FIG. 2, the acceleration sensor 10 and the ice detection sensor 20a are connected to the evaluation device 30 in the area of the rotor blade root by means of a wired line. The term wired, as used herein, comprises an electrical connection and/or an optical, for example, fiber optical connection. The ice detection sensor 20b in the area of the rotor blade tip is configured to transmit the direct detection result to the evaluation device 30 in a wireless manner. Thus, the flexibility is increased, and the ice detection sensor 20b may be easily installed in the area of the rotor blade tip to the rotor blade tip without providing additional data lines or signal lines.

In embodiments, it is provided for the at least one acceleration sensor 10 and/or the at least one ice detection sensor 20, 20a, 20b to comprise an energy harvesting device 40. In the embodiment illustrated in FIG. 2, for example, the detection sensor 20b exhibits an energy harvesting device 40 in the area of the rotor blade tip, which energy harvesting device 40 is configured to supply the detection sensor 20b with energy for performing the direct detection and for performing the transmission of the detection result to the evaluation device 30. The disclosure is not restricted to a single energy harvesting device 40 per sensor, and a sensor 20, 20a, 20b may also be supplied with energy by a plurality of energy harvesting devices 40. Thus, the flexibility is increased, and the ice detection sensor 20b in the area of the rotor blade tip may be easily installed to the rotor blade tip without providing additional energy supply lines.

In embodiments, it is provided for the device to further comprise a warning device 50 (see FIG. 1). The warning device 50 is configured to output an ice warning message if the determination is made that an attachment of ice is given. Alternatively, or additionally, the warning device 50 is configured to output a free-of-ice message if the determination is made that an attachment of ice is not given. For example, the warning device 50 is supplied with the evaluation signal 35 from the evaluation device 30. The warning device 50 outputs the ice warning message or the free-of-ice message as a warning signal 55.

It is conceivable for the warning signal 55 to be employed in the use of a plant control for a wind turbine. For example, the wind turbine may be stopped or decelerated or slowed down when an ice warning message is given. In case of a free-of-ice message, the wind turbine may be released or started again. By combining direct and indirect detecting, a free-of-ice message may be obtained even when the plant is at standstill, where the indirect detection does not work at all or only in a restricted manner.

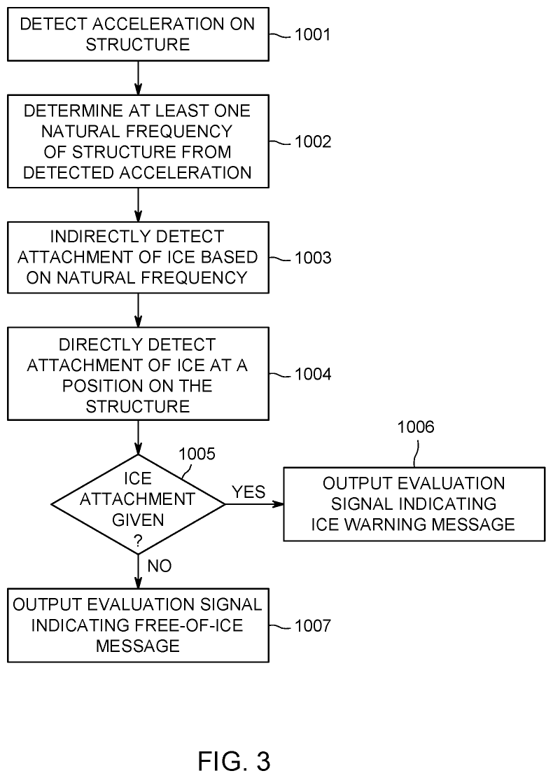

FIG. 3 shows a flow chart of a method for recognizing the attachment of ice to a structure 110 of an edifice according to one embodiment. The structure 110 is a rotor blade of a wind turbine, for example.

In a step 1001, an acceleration is detected on the structure 110. In a subsequent step 1002, at least one natural frequency of the structure 110 is determined from the detected acceleration. In a subsequent step 1003, an attachment of ice to the structure 110 is indirectly detected on the basis of the determined at least one natural frequency of the structure 110. In a subsequent step 1004, an attachment of ice at a position on the structure 110 is directly detected.

In a step 1005, a determination is subsequently made whether or not an ice attachment is given, and namely from a combination of the direct detection result and the indirect detection result. When it is determined in step 1005 that an ice attachment is given, it is continued with step 1006. When it is determined in step 1005 that an ice attachment is not given, the process is continued with step 1007.

In step 1006, an evaluation signal indicating an ice warning message is output as the result of the evaluation.

In step 1007, an evaluation signal indicating a free-of-ice message is output as the result of the evaluation.

It may be provided for the method to be repeated following step 1006 or step 1007, for example, continuously repeated.

The sequence of steps 1001, 1002, 1003 for performing the indirect detection, on the one hand, in relation to step 1004 for performing the direct detection, on the other, is not restricted to this example, and it may likewise be provided for step 1004 for performing the direct detection to be executed before steps 1001, 1002, 1003 for performing the indirect detection, or for steps 1001, 1002, 1003 for performing the indirect detection to be executed simultaneously with step 1004 for performing the direct detection.

It should be noted at this point that the aspects and embodiments described herein are appropriately combinable with one another, and that individual aspects may be omitted there where it is reasonable and possible within the scope of skilled action. Modifications and additions of the aspects described herein are well known to the skilled person.

1. A device for recognizing the attachment of ice to a structure of an edifice, the device comprising:
at least one acceleration sensor that is arranged and configured to detect an acceleration on the structure;
an evaluation device for determining at least one natural frequency of the structure from the detected acceleration, wherein the evaluation device is configured to indirectly detect attachment of ice to said structure on the basis of the determined at least one natural frequency of the structure;
at least one ice detection sensor that is arranged and configured to directly detect attachment of ice at a position on said structure,
wherein the evaluation device combines the indirect detection of the attachment of ice and the direct detection of the attachment of ice.

2. The device according to claim 1, wherein the indirect detection of the attachment of ice to the structure comprises:
comparing the determined at least one natural frequency with at least one reference natural frequency;
determining a shift between the determined at least one natural frequency and the at least one reference natural frequency.

3. The device according to claim 2, wherein the combining of the indirect detection of the attachment of ice and of the direct detection of the attachment of ice comprises:
determining, in the indirect detection, that an attachment of ice is given when a shift between the determined at least one natural frequency and the at least one reference natural frequency exceeds a previously defined or definable threshold value of shift;
determining, in the direct detection, that an attachment of ice is given when a detection value of the attachment of ice exceeds a previously defined or definable threshold value of ice thickness.

4. The device according to claim 1, wherein the at least one ice detection sensor is selected from the following group: impedance sensor, electrical resistance sensor, ultrasonic sensor, optical sensor for measuring a light intensity or a change in light intensity, optical sensor for measuring a light wavelength or a change in light wavelength, fiber Bragg grating sensor.

5. The device according to claim 1, wherein the structure is a rotor blade of a wind turbine.

6. The device according to claim 5, wherein the at least one ice detection sensor is arranged at one or more of the following positions: area of the rotor blade front edge, area of the rotor blade tip, area of the rotor blade root.

7. The device according to claim 1, wherein the at least one acceleration sensor and/or the at least one ice detection sensor is or are configured to supply the evaluation device in a wireless manner with the detected acceleration or the detection result.

8. The device according to claim 1, wherein the at least one acceleration sensor and/or the at least one ice detection sensor exhibit or exhibits at least one energy harvesting device.

9. The device according to claim 1, further comprising a warning device, wherein the warning device is configured to output an ice warning message if the determination is made that an attachment of ice is given, and/or wherein the warning device is configured to output a free-of-ice message if the determination is made that an attachment of ice is not given.

10. A method for recognizing the attachment of ice to a structure of an edifice, the method comprising:
detecting an acceleration on the structure;
determining at least one natural frequency of the structure from the detected acceleration;
indirectly detecting an attachment of ice on the structure on the basis of the determined at least one natural frequency of the structure;
directly detecting the attachment of ice at a position on the structure;
determining, from a combination of the direct detection result and the indirect detection result, whether or not an ice attachment is given.
